(19) United States
(12) Patent Application Publication
(10) Pub. No.: US 2011/0219897 A1
(43) Pub. Date: Sep. 15, 2011

(54) POWER TRANSMISSION APPARATUS

(75) Inventors: Yuzo Ohkawa, Hiroshima-shi (JP); Hidenori Nishiura, Hiroshima-shi (JP)

(73) Assignee: Mazda Motor Corporation, Aki-gun (JP)

(21) Appl. No.: 12/938,293

(22) Filed: Nov. 2, 2010

(30) Foreign Application Priority Data
Mar. 15, 2010 (JP) 2010-058059

(51) Int. Cl. F16H 1/14

(52) U.S. Cl. 74/417

(57) ABSTRACT

There is provided, in one aspect of the present description, a power transmission apparatus. In one example, the power transmission apparatus comprises, a first driving shaft extending in a first direction, a second driving shaft extending in a second direction, a bevel driving gear arranged on the first driving shaft, and a bevel driven gear arranged on the second driving shaft and meshed with the bevel driving gear. The power transmission apparatus further comprises a fitting shaft formed on the first driving shaft, a fitting hole formed in the bevel driving gear, a contacting surface contacting the first driving shaft so as to restrict movement of the bevel driving gear in a first axial direction, and a snap ring installed so as to restrict movement of the bevel driving gear in a second axial direction that is opposite to the first axial direction.

### BACKGROUND

The present description relates to a power transmission apparatus which transmits power through a bevel gear set between two shafts, and more particularly to a method to assemble such an apparatus.

An automotive vehicle with an engine transversely mounted in a front part of a vehicle body has a transaxle which consists of a variable speed transmission that varies speed of the power from the engine and a front differential gear apparatus that transmits the speed changed power to drive shafts for the front wheels.

To provide such a transversely mounted engine vehicle with a four wheel drive function, there is known, and, for example, described in Japanese patent application publication 10-291424, a bevel gear set through which the power is transmitted from an output shaft that is built in the transaxle and extends in the vehicle width direction to a propeller shaft that extends in the vehicle longitudinal direction to a rear differential gear apparatus.

In the Japanese publication, a hollow output shaft extending in the vehicle width direction is built into the transaxle. The output shaft is fitted onto one of front wheel drive shafts which extend from the front differential gear apparatus in the vehicle width direction and splines fitted to a differential gear case of the front differential gear apparatus. Therefore, when power is transmitted from an output shaft of the variable speed transmission to a ring gear of the front differential gear mechanism, the output shaft is rotationally driven together with the differential gear case. Further, a bevel drive gear is coupled to the output shaft for transmitting power to the rear wheels.

In particular, the output shaft is fixed to a flange portion provided at the outer peripheral surface of the output shaft by using a plurality of bolts.

As a result, there is room to reduce number of parts and amount of time to assemble the apparatus.

### SUMMARY

The inventors herein have rigorously studied and unexpectedly found a power transmission apparatus which solve disadvantages of the prior art and present further advantages.

Accordingly, there is provided, in one aspect of the present description, a power transmission apparatus comprising a first driving shaft extending in a first direction, a second driving shaft extending in a second direction different from the first direction, a bevel driving gear which is arranged on and coaxially with the first driving shaft, a bevel driven gear which is arranged on and coaxially with the second driving shaft and is meshed with the bevel driving gear, splines formed on the first driving shaft, and grooves formed on an inner, peripheral surface of the bevel driving gear to be mated with the splines. The power transmission apparatus further comprises a fitting shaft which is formed on and integrally and coaxially with the first driving shaft, a fitting hole which is formed in the bevel driving gear and has a fitting surface that fits the outer surface of the fitting shaft, a contacting surface which is formed on the bevel driving gear between the grooves and the fitting hole in the axial direction and contacts the first driving shaft so as to restrict a movement of the bevel driving gear relative to the first driving shaft in a first axial direction, and a snap ring which is installed on one of the first driving shaft and bevel driving gear and contacts the other of the first driving shaft and bevel driving gear so as to restrict a movement of the bevel driving gear relative to the first driving shaft in a second axial direction that is opposite to the first axial direction.

According to the one aspect of the present description, the splines of the first driving shaft and the grooves of the bevel driving gear can provide a secure power transmission. The fitting shaft of the first driving shaft and the fitting surface of the fitting hole of the bevel driving gear can certainly secure a radially positioning accuracy of the bevel driving gear. The contacting surface of the first driving shaft and the snap ring can certainly secure an axially positioning accuracy of the bevel driving gear. Therefore, three dimensional positioning accuracy of the bevel driving gear can be certainly secured without using bolts. As a result, number of parts and time to assemble the apparatus can be reduced without increasing gear noise caused by inaccuracy of positioning the bevel gear.

In embodiments, there may be provided a circumferential groove which is formed in the fitting hole of the bevel driving gear and accommodates the snap ring so as to radially inwardly bias the snap ring and has a guide surface that is angled so as to guide the snap ring in the first axial direction when it is radially biased. When the shaft and bevel gear rotate in operation, the snap ring also rotates and is further forced to the guide surface of the circumferential groove by the centrifugal force in addition to the bias force. As a result, the bevel driving gear is further forced in the first axial direction and to the contacting surface leading to more accurate axial positioning of the bevel driving gear.

Further in the embodiments, the diameter of the fitting hole may be greater than the diameter of the splines, and the splines, the contacting surface and the fitting hole may be aligned in this order from a teeth side of the bevel gear in the axial direction. Therefore, the contacting surface can have the greater diameter since it is located at the side of the fitting hole not at the end of the splines. And, it can receive more thrust force. Further, centering accuracy of the bevel driving gear can be greater thanks to the greater diameter of the fitting hole. As a result, the positioning accuracy of the bevel driving gear can be further enhanced.

Further in the embodiments, the fitting surface may be configured so that the fitting surface begins contacting the fitting shaft after the splines and grooves have started being mated when the bevel driving gear is axially assembled with the first driving shaft. Therefore, the radial positioning of the bevel driving gear can be started after the angular positioning has started so as to make the assembling of the gear and shaft easier.

### BRIEF DESCRIPTION OF THE DRAWINGS

FIG. 1 is a schematic view showing a power transmission apparatus according to a first embodiment of the present invention.

FIG. 2 is a cross-sectional view of the power transmission apparatus shown in FIG. 1.

FIG. 3 is an enlarged cross-sectional view showing a substantial part of the power transmission apparatus shown in FIG. 2.

FIG. 4 is a cross-sectional view showing a process of fitting a bevel driving gear onto a transfer input shaft.

FIG. 5 is a schematic view showing a power transmission apparatus according to a second embodiment of the present invention.

FIGS. 6A to 6C are views showing mounting positions of snap rings according to another embodiment of the present invention.

### DESCRIPTION OF THE EMBODIMENTS

Hereinafter, embodiments of the present invention are described with reference to the appended drawings.

### First Embodiment

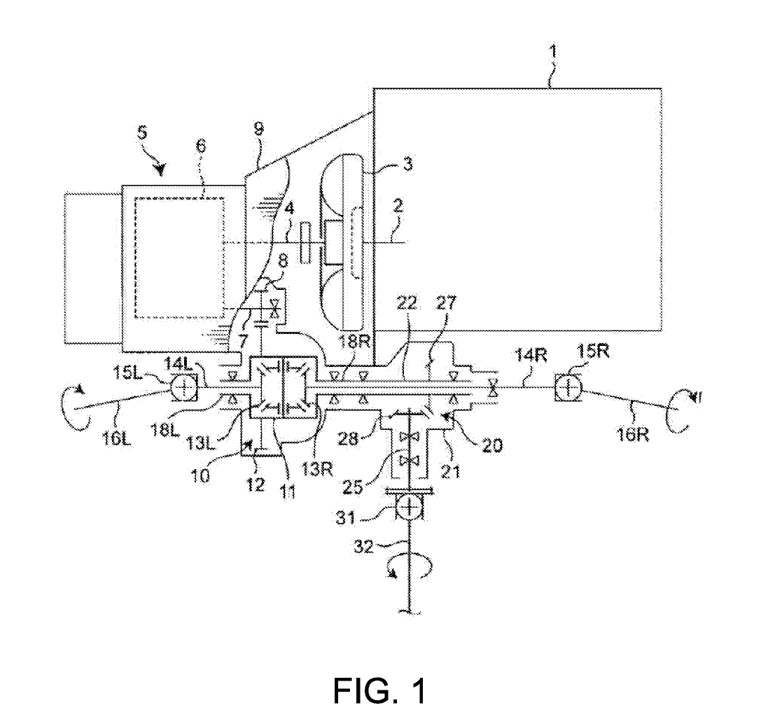

FIG. 1 is a schematic view showing power transmission paths of a four-wheel-drive car according to a first embodiment of the invention. Triangles shown in FIG. 1 represent bearings.

In the four-wheel-drive car shown in FIG. 1, a transverse or east-west engine 1 is mounted in an engine room located in a front part of a car body. The engine 1 is provided with a crankshaft 2 extending in a vehicle width direction.

A torque converter 3 is coupled in series to the crankshaft 2. An automatic transmission 6 is coupled in series to a turbine shaft 4 of the torque converter 3. An output shaft 7 of the transmission 6 extends in the vehicle width direction, and an output gear 8 is provided to the output shaft 7. A motive force slowed down by the transmission 6 is transmitted to a differential 10 for front wheels (front differential) via the output gear 8. In this embodiment, although the automatic transmission is used as the transmission 6, the transmission 6 is not limited to the automatic transmission and may be a manual transmission or a continuously variable transmission.

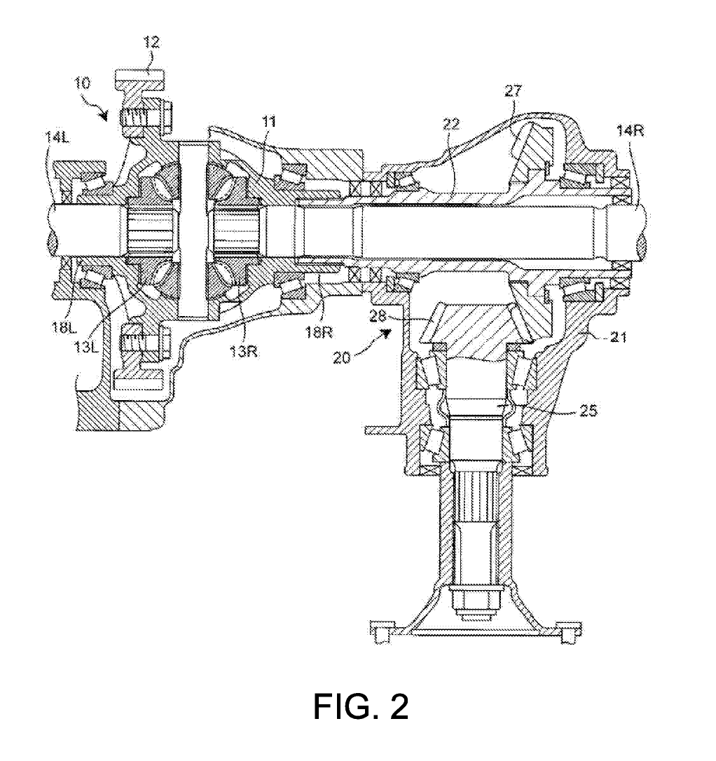

A configuration of the front differential 10 is described referring to FIGS. 1 and 2. The front differential 10 has a differential casing 11. A ring gear 12 assembled to the differential casing 11 mates with the output gear 8 of the transmission 6. Left and right shaft insertion sections 18L and 18R are provided to the differential casing 11 so as to correspond to left and right side gears 13L and 13R accommodated in the differential casing 11. Driving shafts 14L and 14R for the front wheels extending in the vehicle width direction are inserted in the left and right shaft insertion sections 18L and 18R. One end part of each of the left and right driving shafts 14L and 14R is spline-fitted into the side gears 13L and 13R, respectively. Axles 16L and 16R for the front wheels are coupled to the other end parts of the left and right driving shafts 14L and 14R via universal joints 15L and 15R, respectively. The front wheels (not illustrated) are connected with the tip ends of the axles 16L and 16R for the front wheels, respectively.

A transaxle 5 constituted with the transmission 6 and the front differential 10, and the torque converter 3 are both accommodated in a transaxle case 9.

A hollow output shaft 22 (first driving shaft) extending in the vehicle width direction is spline-fitted into the right shaft insertion section 18R of the front differential 10. Because the output shaft 22 has both a function as an output shaft of the front differential 10 (i.e., the output shaft 22) and a function as an input shaft of a transfer 20, it is also referred herein to as a “transfer input shaft 22.”

The transfer 20 includes the transfer input shaft 22, a bevel driving gear 27 provided to the transfer input shaft 22, a transfer output shaft 25 (second driving shaft) extending in a vehicle front-and-rear direction, and a bevel driven gear 28 provided to a front end part of the transfer output shaft 25. The bevel driving gear 27 is formed in an annular shape, and is coupled and fitted onto the transfer input shaft 22. In this embodiment, hypoid gears, where axial centers of the gears are offset in an up-and-down direction, are used as the bevel driving gear 27 and the bevel driven gear 28. Thereby, it is advantageous in terms of a gear-noise reduction and an improvement of structural strength. However, in this embodiment, bevel gears other than the hypoid gears may also be used as the bevel driving gear 27 and the bevel driven gear 28.

Various members constituting the transfer 20 are accommodated in a transfer case 21.

A propeller shaft 32 is coupled to a rear end part of the transfer output shaft 25 via a universal joint 31, and, thereby, the output of the transfer 20 is transmitted to the rear wheel side via the propeller shaft 32.

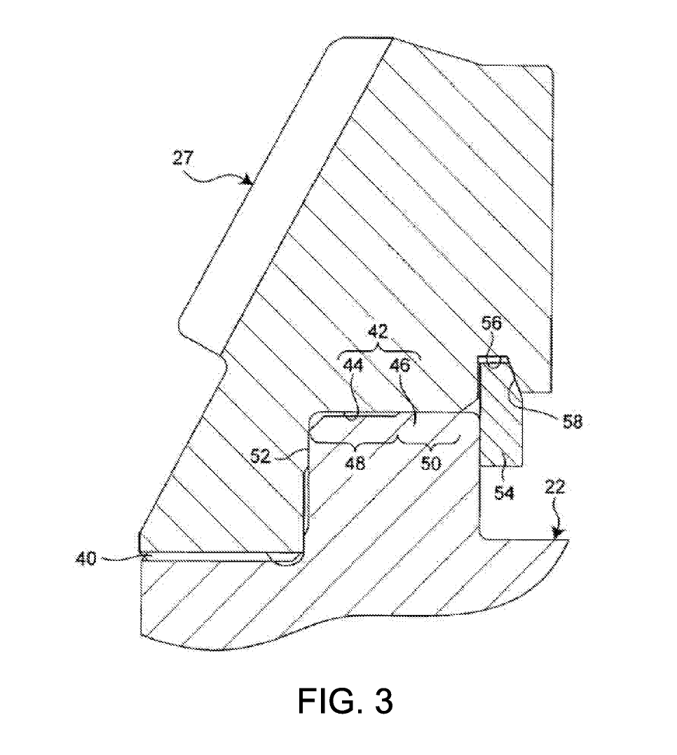

A mounting structure of the bevel driving gear 27 to the transfer input shaft 22 is described in detail referring to the enlarged view shown in FIG. 3.

The bevel driving gear 27 is fitted onto the transfer input shaft 22 via a spline section 40 and a fitting section 42.

In the spline section 40, because the bevel driving gear 27 and the transfer input shaft 22 are spline-fitted, a motive force is certainly transmitted from the transfer input shaft 22 to the bevel driving gear 27.

The fitting section 42 includes a fitting hole part 44 formed in an inner circumferential surface of the bevel driving gear 27, and a fitting shaft part 46 formed in an outer circumferential surface of the transfer input shaft 22.

An inner diameter of the fitting hole part 44 is uniform over the substantially entire width thereof in the axial direction. For this reason, the fitting hole part 44 is suitably used as a reference of various dimensions of the bevel driving gear 27 in fabrication thereof.

The fitting shaft part 46 is formed by a flange-shaped projection part formed in the outer circumferential surface of the transfer input shaft 22. An outer diameter of a portion of the fitting shaft part 46 from an end on the side of the spline section 40 in the axial direction to a central part thereof is made slightly smaller than the inner diameter of the fitting hole part 44, and, thereby, a loose-fitting part 48 where the fitting shaft part 46 is loosely fitted into the fitting hole part 44 is formed. Moreover, an outer diameter of a portion of the fitting shaft part 46 from the central part in the axial direction to an end opposite from the spline section 40 is made substantially equal to or slightly larger than the inner diameter of the fitting hole part 44, and, thereby, a press-fitting part 50 where the fitting shaft part 46 is press-fitted into the fitting hole part 44 is formed. As described above, because the press-fitting part 50 is formed in the fitting section 42, a positional accuracy of the bevel driving gear 27 in the diameter direction is secured appropriately.

The fitting section 42 is larger in diameter than the spline section 40. Therefore, a centering accuracy of the fitting hole part 44 and the fitting shaft part 46 can be improved, and diameter accuracies of the fitting hole part 44 and the fitting shaft part 46 can be improved in their fabrication. Accordingly, the positional accuracy of the bevel driving gear 27 in the diameter direction can be further improved, and the bevel driving gear 27 can be attached in the diameter direction without any clearance.

Between the spline section 40 and the fitting section 42, contacting surfaces 52 at which the transfer input shaft 22 and the bevel driving gear 27 contact to each other, so that a relative displacement between the transfer input shaft 22 and the bevel driving gear 27 in the axial direction is inhibited, are formed. The contacting surfaces 52 are formed substantially perpendicularly to the axial direction.

Further, along the axial direction, the spline section 40 and the fitting section 42 are arranged in this order from a tooth flank side of the bevel driving gear 27. For this reason, a thrust force given from the bevel driving gear 27 can be received at the contacting surface 52 on the side of the fitting section 42. Therefore, compared with the case where the thrust force is received at the contacting surface 52 on the side of the spline section 40, the thrust force can be received certainly and a high mounting strength of the bevel driving gear 27 can be obtained.

The bevel driving gear 27 is mounted with a snap ring 54 that contacts the transfer input shaft 22 so that a relative displacement between the transfer input shaft 22 and the bevel driving gear 27 in the axial direction on the opposite side of the contacting surface 52 is inhibited. For this reason, the relative displacement in the axial direction between the transfer input shaft 22 and the bevel driving gear 27 is inhibited by the contacting surface 52 and the snap ring 54, and, thereby, a positional accuracy of the bevel driving gear 27 can be secured appropriately also in the axial direction. Accordingly, a teeth contact of the bevel driving gear 27 and the bevel driven gear 28 which mates therewith can be maintained appropriately, and a gear noise can be suppressed.

A circumferential groove 56 to which the snap ring 54 is mounted is formed in the inner circumferential surface of the fitting hole part 44. The circumferential groove 56 has a taper surface 58 that generates the thrust force for pressing the snap ring 54 toward the contacting surface 52 by a biasing force of the snap ring 54. The taper surface 58 is formed in a side face of the circumferential groove 56 on the side far from the contacting surface 52 so that its diameter expands as it goes toward the contacting surface 52 in the axial direction.

The snap ring 54 becomes large in diameter at the time of an unmounted state rather than the time in the mounted state to the circumferential groove 56. The mounting of the snap ring 54 is performed by inserting the snap ring 54 into the fitting hole part 44 while reducing the diameter of the snap ring 54, and then, fitting the snap ring 54 into the circumferential groove 56 while expanding the diameter. Thereby, the snap ring 54 is mounted to the circumferential groove 56 in a state where it is biased in the diameter expanding direction.

During transmission of the motive force, a centrifugal force in the diameter expanding direction is caused in the snap ring 54. Therefore, the biasing force and the centrifugal force in the diameter expanding direction of the snap ring 54 act on the mounting part of the snap ring 54, and, thereby, dropping-off of the snap ring 54 can be prevented.

The snap ring 54 in the mounted state contacts the taper surface 58 of the circumferential groove 56, but does not contact a bottom face of the circumferential groove 56. For this reason, because the entire biasing force in the diameter expanding direction of the snap ring 54 is received at the taper surface 58 of the circumferential groove 56, the taper surface 58 can certainly generate a reaction force in the thrust direction on the side of the contacting surface 52 by the biasing force. Meanwhile, the snap ring 54 in the mounted state contacts a face opposite from the contacting surface 52 of the fitting shaft part 46 in the axial direction, but does not contact a side face of the circumferential groove 56 which opposes the taper surface 58. For this reason, the thrust force generated by the taper surface 58 of the circumferential groove 56 is certainly transmitted to the fitting shaft part 46 by the contacting faces of the snap ring 54 and the fitting shaft part 46. Thus, the fitting shaft part 46 can be firmly pinched between the contacting surface 52 and the snap ring 54 by the thrust force. Therefore, rattling of the bevel driving gear 27 in the axial direction can be certainly prevented, and the positional accuracy of the bevel driving gear 27 in the axial direction can be further improved.

As described above, because the bevel driving gear 27 is fixed to the transfer input shaft 22 only using a single snap ring 54, the number of components can be reduced and assembling work can be simplified, for example, comparing with the conventional technology in which two or more bolts are used for fastening. Therefore, the cost can be reduced.

The transfer input shaft 22 and the bevel driving gear 27 are so designed in size that, when the bevel driving gear 27 is fitted and assembled to the transfer input shaft 22, the press-fitting of the press-fitting part 50 of the fitting section 42 is started after the engagement in the spline section 40 is started.

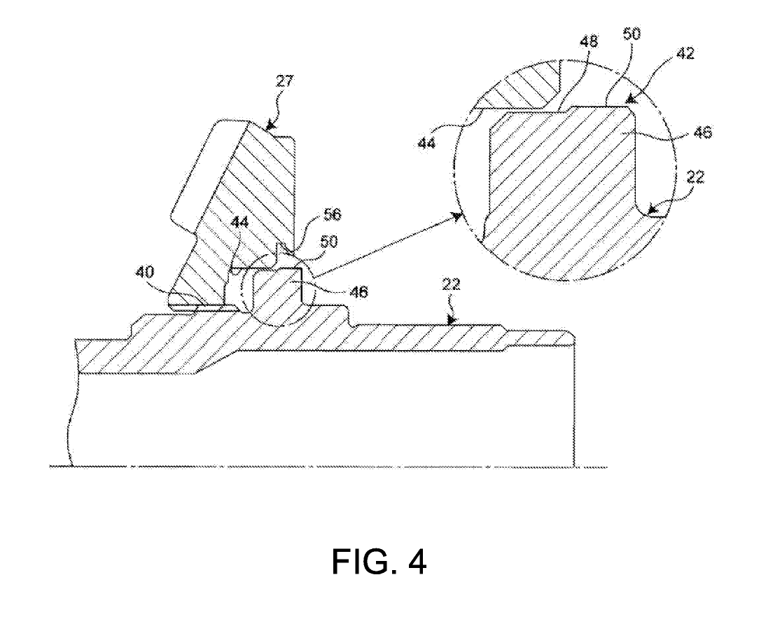

More specifically, as shown in FIG. 4, when the bevel driving gear 27 is fitted onto the transfer input shaft 22, the spline-fitting between the transfer input shaft 22 and the bevel driving gear 27 of the spline section 40 is first started. At this time, in the fitting section 42, fitting of the press-fitting part 50 is not started, but only fitting of the loose-fitting part 48 is started. For this reason, mating of the spline section 40 can be carried out easily and securely. Therefore, compared with the case where the mating of the spline section 40 is carried out after the start of press-fitting of the fitting section 42, the fitting work of the bevel driving gear 27 can be easily carried out.

### Second Embodiment

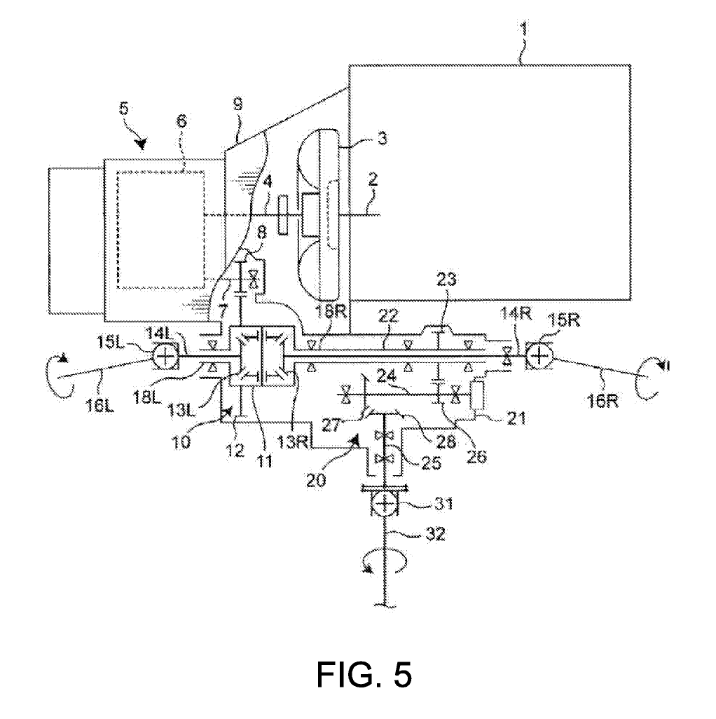

FIG. 5 is a schematic view showing power transmission paths of a four-wheel-drive car according to another embodiment. Triangles in FIG. 5 represent bearings, similar to those of FIG. 1. Further, in FIG. 5, members having similar configurations as those of the first embodiment are given with the same reference numerals as FIG. 1.

In this embodiment, a configuration of the transfer 20 differs from the first embodiment, and other configurations are similar to those of the first embodiment.

The transfer 20 of this embodiment includes an idle shaft 24 extending in the vehicle width direction, as well as the transfer input shaft 22 and the transfer output shaft 25 described in the first embodiment. The idle shaft 24 is provided with a follower gear 26 that mates with a driving gear 23 provided on the transfer input shaft 22, and the bevel driving gear 27 that mates with the bevel driven gear 28 provided on the transfer output shaft 25.

That is, a motive force inputted to the transfer input shaft 22 is transmitted to the idle shaft 24 via the driving gear 23 and the follower gear 26. The motive force transmitted to the idle shaft 24 is then transmitted to the transfer output shaft 25 via the bevel driving gear 27 and the bevel driven gear 28.

The bevel driving gear 27 is attached to the idle shaft 24 by a similar structure as the attaching structure to the transfer input shaft 22 in the first embodiment, and, thereby, a similar effect to the first embodiment can be acquired.

In the above, the present invention is described with reference to the above embodiments. However, the present invention is not limited to the above embodiments.

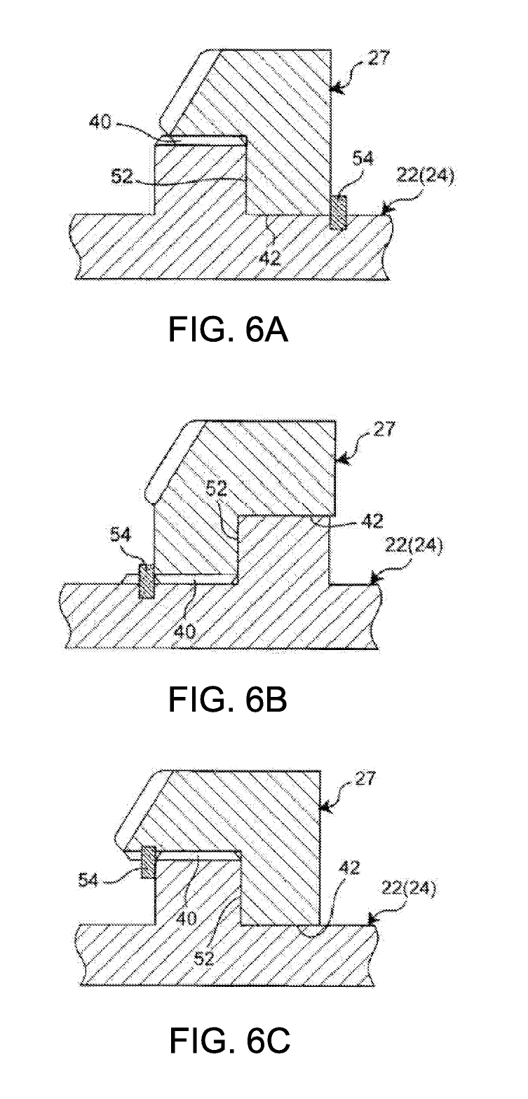

For example, in the above embodiments, the configuration where the snap ring 54 mounted to the bevel driving gear 27 is contacted to the first driving shaft (the transfer input shaft 22 or the idle shaft 24) to pinch the fitting section 42 by the snap ring 54 and the contacting surface 52. However, the present invention is not limited to this. That is, the present invention may include the following configurations: for example, as shown in FIG. 6A, the snap ring 54 mounted to the first driving shaft 22 (24) is contacted to the bevel driving gear 27 to pinch the fitting section 42 by the snap ring 54 and the contacting surface 52; for example, as shown in FIG. 6B, the snap ring 54 mounted to the first driving shaft 22 (24) is contacted to the bevel driving gear 27 to pinch the spline section 40 by the snap ring 54 and the contacting surface 52; and, for example, as shown in FIG. 6C, the snap ring 54 mounted to the bevel driving gear 27 is contacted to the first driving shaft 22 (24) to pinch the spline section 40 by the snap ring 54 and the contacting surface 52.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A power transmission apparatus comprising:
a first driving shaft extending in a first direction;
a second driving shaft extending in a second direction different from said first direction;
a bevel driving gear which is arranged on and coaxially with said first driving shaft;
a bevel driven gear which is arranged on and coaxially with said second driving shaft and is meshed with said bevel driving gear;
splines formed on said first driving shaft; grooves formed on an inner, peripheral surface of said bevel driving gear to be mated with said splines;
a fitting shaft which is formed on and integrally and coaxially with said first driving shaft;
a fitting hole which is formed in said bevel driving gear and has a fitting surface that fits an outer surface of said fitting shaft;
a contacting surface which is formed on said bevel driving gear between said grooves and said fitting hole in an axial direction and contacts said first driving shaft so as to restrict a movement of said bevel driving gear relative to said first driving shaft in a first axial direction; and
a snap ring which is installed to one of said first driving shaft and bevel driving gear and contacts the other of said first driving shaft and bevel driving gear so as to restrict a movement of said bevel driving gear relative to said first driving shaft in a second axial direction that is opposite to said first axial direction.

2. The power transmission apparatus as described in claim 1, further comprising a circumferential groove which is formed in said fitting hole of said bevel driving gear and accommodates said snap ring so as to radially inwardly bias said snap ring and has a guide surface that is angled so as to guide said snap ring in said first axial direction when it is radially biased.

3. The power transmission apparatus as described in claim 2, wherein a diameter of said fitting hole is greater than a diameter of said splines, and wherein said splines, said contacting surface and said fitting hole are aligned in this order from a teeth side of said bevel gear in the axial direction.

4. The power transmission apparatus as described in claim 3, wherein said fitting surface is configured so that said fitting surface begins contacting said fitting shaft after said splines and grooves have started being mated when said bevel driving gear is axially assembled with said first driving shaft.

5. The power transmission apparatus as described in claim 1, wherein a diameter of said fitting hole is greater than a diameter of said splines, and wherein said splines, said contacting surface and said fitting hole are aligned in this order from a teeth side of said bevel gear in the axial direction.

6. The power transmission apparatus as described in claim 5, wherein said fitting surface is configured so that said fitting surface begins contacting said fitting shaft after said splines and grooves have started being mated when said bevel driving gear is axially assembled with said first driving shaft.

7. The power transmission apparatus as described in claim 1, wherein said fitting surface is configured so that said fitting surface begins contacting said fitting shaft after said splines and grooves have started being mated when said bevel driving gear is axially assembled with said first driving shaft.
